(19) United States
(12) Patent Application Publication
(10) Pub. No.: US 2005/0078564 A1
(43) Pub. Date: Apr. 14, 2005

(54) Floating slider, and magneto-optical storage device comprising it

(76) Inventors: Goro Kawasaki, Kawasaki (JP); Koichi Tezuka, Kawasaki (JP)

Correspondence Address: GREER, BURNS & CRAIN, 300 S WACKER DR, 25TH FLOOR, CHICAGO, IL, 60606, US

(21) Appl. No.: 10/502,304

(22) PCT Filed: Jan. 22, 2002
(86) PCT No.: PCT/JP02/00443

(51) Int. Cl. G11B 11/00

(52) U.S. Cl. 369/13.14; 369/13.24

(57) ABSTRACT

A floating slider (1) includes an opposing face (11) opposed to a storage medium (Dc). The opposing face (11) has a crown surface (7) like an outer columnar surface having an axis extending radially of the storage medium. The floating slider (1) is floated off the storage medium (Dc) by air flowing in between the storage medium (Dc) and the opposing surface (11). In the floating slider (1), the following expression is satisfied where d represents a crown thickness defined as a distance from an vertex of an arc in a section of the crown surface (7) to a chord of the arc, and L represents a slider length defined as a length of the opposing face parallel to the chord:
250(nm/mm)×L(mm)≦d(nm)≦250(nm/mm)×L(mm)+1500(mm)

### TECHNICAL FIELD

The present invention relates to floating sliders used in storage devices which record and/or replay information to and from rotating storage media. The present invention also relates to storage devices including the floating slider.

### BACKGROUND ART

A magnetic storage device such as a hard disc drive is a storage device of this kind. The hard disc drive incorporates storage media having surfaces formed with magnetic storage layers. The magnetic storage layer has storage regions (marks) each representing a single bit of information, and each mark can be magnetized in one orientation of S-N and N-S, thereby recording information, or the orientation can be read out, thereby replaying the stored information. Such a magnetic recording device includes a magnetic field generator for generating a magnetic field near the mark, and the generator is mounted on a floating slider which can position itself off the storage medium when the storage medium is rotating.

The floating slider is elastically pressed against the storage medium, and is slightly floated off the storage medium when the storage medium rotates, by a pressure increase in a fluid wedge formed between the rotating storage medium and the slider. Such a floating slider can position itself off the storage medium without depending on any position controlling mechanisms, and therefore has begun being used also in storage devices which use removable storage media such as optical discs and magneto-optical discs.

Magneto-optical discs have a magnetic recording layer which has a relatively strong coercive force so that recorded information will not be erased easily. Magneto-optical storage devices which use magneto-optical discs apply a laser beam to increase temperature and thereby reduce coercive force at each mark, and then magnetize the marks thereby recording information. When replaying the information, a laser beam is applied to the marks, which reflect the beam at different polarizing angles unique to the direction of magnetization. By reading this angle, the information is replayed. Among such magneto-optical storage devices is a type which uses the magnetic-field modulation method. In this method, when the marks are magnetized, the laser beam is applied constantly in order to maintain a high-temperature state of the magnetic recording layer while the magnetic-field generated by the magnetic-field generator is modulated. Some of the devices of this type use a floating slider which is provided with the magnetic-field generator and an object lens for forming a beam spot. In such a floating slider, the area of surface opposed to the storage medium is larger than that of a floating slider incorporated in a magnetic storage device.

In line with this, there is increasing demand recently for magnetic or magneto-optical storage devices of greater capacities, and there is concomitant demand for storage media of higher storage densities. Under such requirements, the area occupied by each mark tends to be made smaller and magnetic force at each mark tends to be weaker. In order to achieve the high-density storage in the storage medium, one technical solution which can be made in the magnetic or the magneto-optical storage device is to minimize the distance between the rotating storage medium and the floating slider (magnetic-field generator) i.e. the amount of floatation of the floating slider, so that magnetizing force when magnetizing the marks will not be weak. Specifically, for a magneto-optical storage device, the amount of floatation of the floating slider should be 2 μm through 4 μm or more preferably abut 3 μm in consideration that a magneto-optical disc which is a removable medium can pick up dust.

However, there is a problem with removable magneto-optical discs. Specifically, for increased handling convenience and lighter weight, the magneto-optical discs use a substrate made of formed resin such as polycarbonate. Differing from hard disc drives which use a precision polished metal substrate made of aluminum for example, the resin substrate has a large formation error, which results in wavy surface circumferentially of the disc, or the overall shape of the disc is somewhat frustum or otherwise not flat. The undulation will result in larger fluctuation in the amount of floatation of the floating slider as the floating slider comes closer to the magneto-optical disc (i.e. as the amount of floatation of the floating slider becomes smaller). The larger fluctuation will result in larger fluctuation in the distance from the object lens to the storage medium, causing the laser beam to come out of focus.

To this problem, the Japanese Patent Laid-Open No. 8-235666 for example proposes a floating slider which can reduce the fluctuation in the amount of floatation. However, the floating slider disclosed in this gazette can reduce fluctuation in the amount of floatation only when the amount of floatation is relatively large (5 μm through 5 μm). Therefore, application of such a slider to a case where the amount of floatation is relatively small (2 μm through 4 μm) does not prevent fluctuation in the amount of floatation.

### DISCLOSURE OF THE INVENTION

The present invention was made under the above-described circumstances, and it is therefore an object of the present invention to provide a floating slider capable of preventing fluctuation in the amount of floatation when the amount of floatation with respect to the rotating storage medium is relatively small.

Another object of the present invention to provide a magneto-optical storage device including such a floating slider.

A first aspect of the present invention provides a floating slider including an opposing face opposed to a storage medium. The opposing face has a crown surface like an outer columnar surface having an axis extending radially of the storage medium. The floating slider is floated off the storage medium by air flowing in between the storage medium and the opposing surface. In the floating slider, the following expression is satisfied where d represents a crown thickness defined as a distance from an vertex of an arc in a section of the crown surface to a chord of the arc, and L represents a slider length defined as a length of the opposing face parallel to the chord:
250(nm/mm)×L(mm)≦d(nm)≦250(nm/mm)×L(mm)+1500(mm)

Preferably, the opposing face has an air entering end formed with a tapered flat surface having a length of 0.3 mm through 0.5 mm toward the chord and crossing the chord at an angle of 0.5 degrees through 1.0 degree.

Preferably, the opposing face has an air entering end formed with a recessed step having a depth of 1 μm through 5 μm.

Preferably, the floating slider is a monorail slider in which the entire crown surface is formed as a single surface.

Preferably, the slider length is 2 mm through 6 mm, a slider width defined as a distance of the opposing face radially of the storage medium is 1.2 mm through 5.0 mm, and the crown thickness d is 500 nm through 3000 nm.

Preferably, the slider length is approximately 6 mm, the slider width defined as a distance of the opposing face radially of the storage medium is approximately 4 mm, and the crown thickness d is 1500 nm through 3000 nm.

A second aspect of the present invention provides a magneto-optical storage device including a light condenser for formation of a laser spot on a storage medium and a magnetic field generator for generation of a magnetic field at a region where the laser spot is formed. In this magneto-optical storage device, the light condenser and the magnetic field generator are mounted on the floating slider provided by the first aspect of the present invention.

Other characteristics and advantages of the present invention will become clearer from the following detailed description to be made with reference to the attached drawings.

### BRIEF DESCRIPTION OF THE DRAWINGS

FIG. 1 is a simplified perspective view of a magneto-optical storage device according to the present invention.

FIG. 2 is a simplified perspective view showing a floating slider in FIG. 1 in enlargement.

FIG. 3 is an exploded perspective view showing an internal construction of the floating slider in FIG. 2.

FIG. 4 is a right side view of the floating slider in FIG. 2.

FIG. 5A and FIG. 5B illustrate a function of the slider in FIG. 2.

FIG. 6 shows a relationship among a crown amount, a slider length and a floatation amount of the floating slider.

FIG. 7 shows a relationship between a slider width and the floatation amount of the floating slider.

FIG. 8 is a simplified side view of another floating slider according to the present invention.

FIG. 9 illustrates advantages of the floating slider in FIG. 2.

### BEST MODE FOR CARRYING OUT THE INVENTION

Hereinafter, embodiments of the present invention will be described specifically, with reference to the attached drawings.

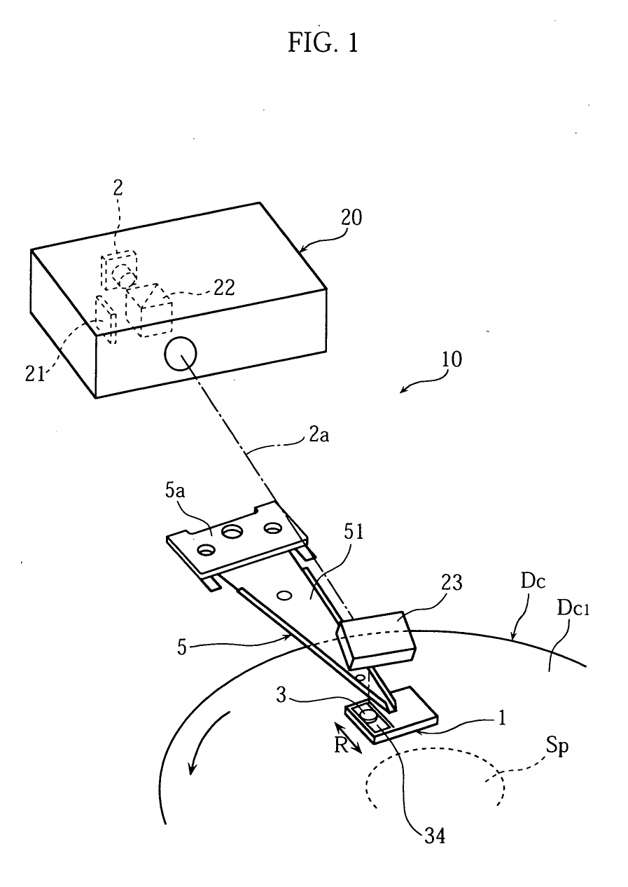

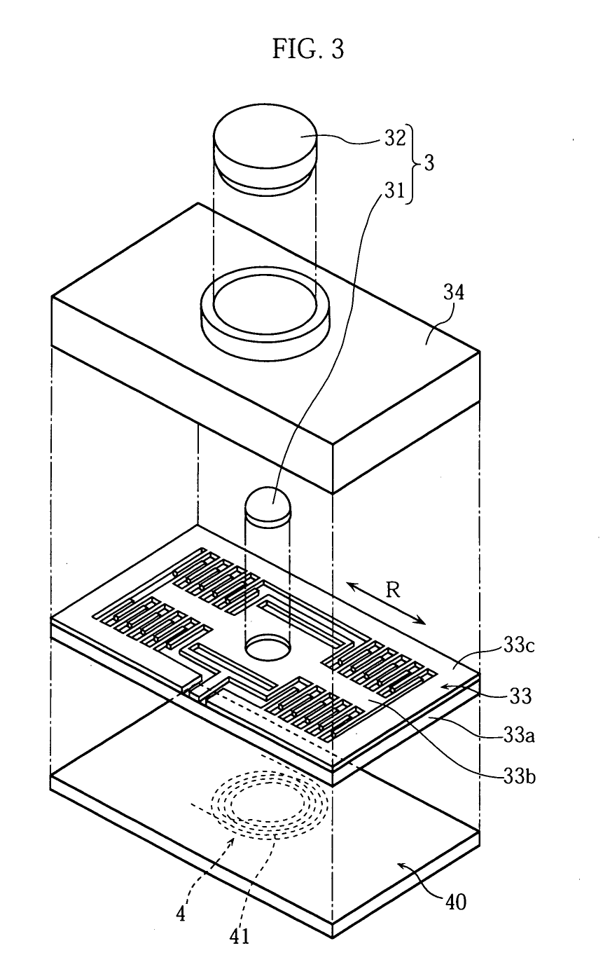

FIG. 1 through FIG. 9 are drawings for describing a floating slider according to the present invention and a magneto-optical storage device including this floating slider. The magneto-optical storage device 10 in FIG. 1 uses a magneto-optical disc Dc as a removable storage medium. While the magneto-optical disc Dc is turned by a spindle Sp, information is recorded in the magneto-optical disc Dc or information recorded in the magneto-optical disc Dc is replayed, using light by means of a magnetic-field modulation method. The magneto-optical storage device 10 includes a light source 2, a beam condenser 3 which condenses the light from the light source 2 and thereby forms a laser beam spot on a surface of the magneto-optical disc Dc, and a magnetic field generator 4 (See FIG. 3) which generates a magnetic field in a region where the laser beam spot is formed in the magneto-optical disc Dc. According to the present embodiment, the beam condenser 3 and the magnetic field generator 4 are mounted on a floating slider 1 which moves relatively to the magneto-optical disc Dc, following the surface of the magneto-optical disc Dc.

The magneto-optical disc Dc includes a thin film-like magnetic recording layer made of a magnetic material, and a resin substrate formed of a resin such as polycarbonate. The magnetic recording layer has storage regions (marks) each representing a single bit of information, and each mark can be magnetized in one orientation of S-N and N-S, thereby recording information. In recent years, recording density in the magneto-optical disc Dc is increasing and there is a requirement that the area occupied by each mark should be decreased.

The light source 2 includes a semiconductor laser element which generates a laser beam. The beam is then made into a parallel flux of beams by e.g. a collimator lens (not illustrated), before being outputted. As shown in FIG. 1, the light source 2 is in an optical unit 20, together with other components such as an optical detector 21 which converts the incident beam (a reflection beam from the magneto-optical disc Dc) into electrical signals, and a beam splitter 22 which allows the beam from the light source 2 to pass through to the magneto-optical disc Dc while reflecting the reflection beam from the magneto-optical disc Dc to the optical detector 21. In order that the magneto-optical storage device 10 will not be excessively large thickness-wise of the magneto-optical disc Dc, the beam outputted from the light source 2 (optical path 2a) travels along a surface of the magneto-optical disc Dc, and the beam is then reflected by a mirror 23 to the beam condenser 3. The mirror 23 is above the beam condenser 3, so the beam from the light source 2 reflected by the mirror 23 enters the beam condenser 3 from above.

Though not illustrated, the magneto-optical storage device 10 also includes a carriage driven by a linear drive mechanism such as a liner voice coil motor. The carriage is movable in radial directions (indicated by an arrow R in FIG. 1) of the magneto-optical disc Dc, and is disposed on the side of a first surface Dc₁ of the magneto-optical disc Dc, whereas a part of the optical path 2a and the mirror 23 are within the carriage.

As shown in FIG. 3, the beam condenser 3 includes a first object lens 31 disposed closer to the magneto-optical disc Dc, and a second object lens 32 disposed farther from the magneto-optical disc Dc, in order to achieve a high numerical aperture. The first object lens 31 is mounted on a micro-positioning controller 33 which makes a very slight shift of the beam spot formed on the magneto-optical disc Dc in radial directions (See FIG. 1) of the magneto-optical disc Dc for tracking control. The second object lens 32 is supported by a casing 34 which covers the micro-positioning controller 33. The first object lens 31 and the second object lens 32 each have a main surface and are mounted on the floating slider 1 so that the main surfaces are parallel to the magneto-optical disc Dc when the magneto-optical disc Dc is turning. The parallel beam flux from the light source 2 is condensed by the second object lens 32 and then condensed further by the first object lens 31, to be focused on the magneto-optical disc Dc as a beam spot. The micro-positioning controller 33 is formed as an electrostatic actuator including a silicon substrate 33a having a rectangular plan view, a movable piece 33b and a fixed piece 33c each made of an electrically conductive material. When a voltage is applied between the movable piece 33b and the fixed piece 33c, the movable piece 33b or the first object lens 31 moves very slightly, relatively to the fixed piece 33c and radially of the magneto-optical disc Dc (in directions indicated by Arrow R in FIG. 3). This causes a slight shift of the beam spot on the magneto-optical disc Dc, by the amount the first object lens 31 has been moved, for controlled tracking.

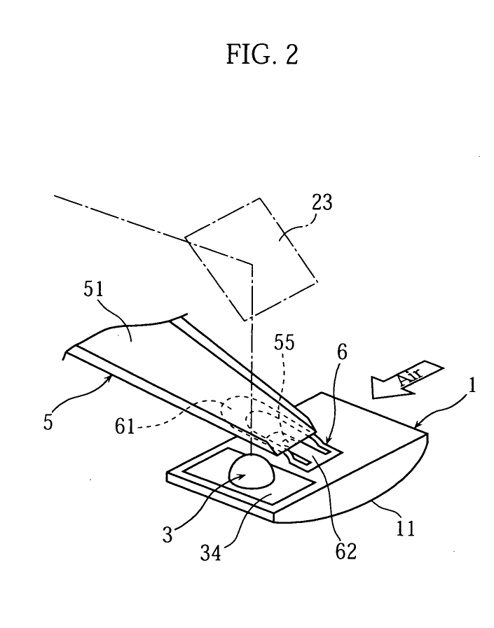

It should be noted here the beam condenser 3 that because the beam from the light source 2 reflects on the mirror 23 and then enters the second object lens 32 from above as shown in FIG. 1 and FIG. 2 a care is taken so that the beam will not be blocked by a suspension member 5. Specifically, the beam condenser 3 is positioned on the floating slider 1 so that the second object lens 32 is off the tip of suspension member 5 in the rotating direction of the magneto-optical disc Dc.

As shown in FIG. 3, the magnetic field generator 4 can be provided for example, by embedding a coil 41 in a transparent substrate 40 which is at the bottom of the silicon substrate 33a, correspondingly to the beam condenser 3. The coil 41 is spiral, made by patterning a film of metal such as copper, covered and thereby embedded in the transparent substrate 40, using a transparent and electrically insulating material such as aluminum oxide, aluminum nitride, diamond-like carbon, silicon oxide and silicon nitride. The magnetic field generator 4 constructed as the above is placed so that the transparent substrate 40 is exposed on the bottom of floating slider 1 and the coil 41 is parallel to the magneto-optical disc Dc. When the coil 41 is energized, a magnetic field is generated to determine the magnetizing orientation of the magnetic recording layer of the magneto-optical disc Dc.

As shown in FIG. 1, the floating slider 1 is supported via a gimbal spring 6 (See FIG. 2) at the tip of the suspension member 5 which extends radially of the magneto-optical disc Dc.

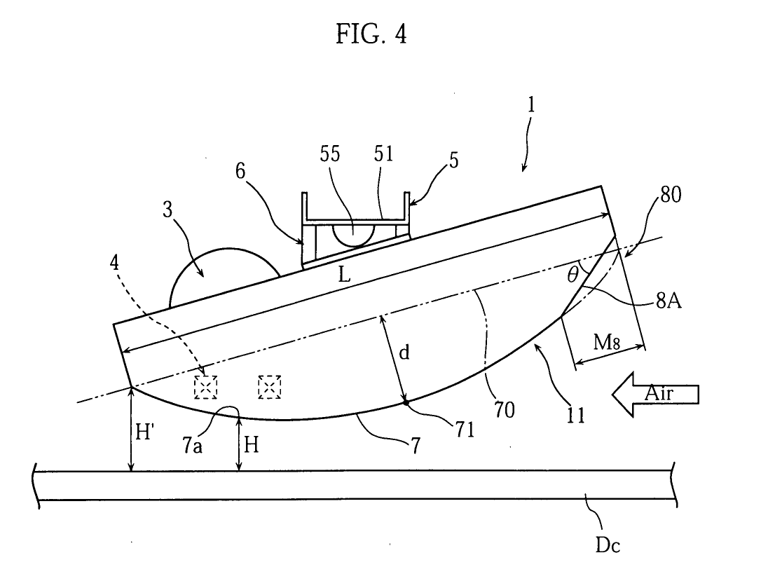

More specifically, as shown in FIG. 2, the gimbal spring 6 has a suspension-side fitting tab 61 connected to the tip of bottom plate 51 of the suspension member 5. The gimbal spring 6 also has a slider-side fitting tab 62 connected to an upper surface of the floating slider 1. In addition, as shown in FIG. 2 and FIG. 4, the bottom plate 51 of the suspension member 5 is formed with a bulge 55 which makes a point contact to a center-of-gravity point of the floating slider 1. With the above arrangement, the floating slider 1 becomes capable of pivoting freely around the bulge 55 which serves as the pivot point. Further, the suspension member 5 has a base 5a which is supported by the unillustrated carriage described earlier. Thus, through the movement of the carriage, the floating slider 1 (the beam condenser 3 and the magnetic field generator 4) is capable of moving relatively to and radially of the magneto-optical disc Dc.

The floating slider 1 is elastically pressed against the magneto-optical disc Dc by the suspension member 5 because the bottom plate 51 of the suspension member 5 is formed as a leaf spring having a predetermined level of elasticity. On the other hand, when the magneto-optical disc Dc is turning at a high speed, air comes in between the floating slider 1 and the magneto-optical disc Dc to form a fluid wedge, which exerts an upward pressure for the floating slider 1 to float slightly off the magneto-optical disc Dc. It should be noted here that while floating above the magneto-optical disc Dc as described, the floating slider 1 leans to a predetermined angle so that a distance to the magneto-optical disc Dc on the downstream side is smaller than a distance to the magneto-optical disc Dc on the upstream side. Under this state, there is a point where the distance from the floating slider 1 to the magneto-optical disc Dc is the smallest, and this point will be called the lowest point 7a. According to the floating slider 1, the beam condenser 3 and the magnetic field generator 4 are aligned with a line that passes the lowest point 7a and is perpendicular to the magneto-optical disc Dc. The distance from the lowest point 7a to the magneto-optical disc Dc will be called the floatation amount H.

In the floating slider 1, in order to read relatively weak magnetism from each mark which is now smaller than before on the magneto-optical disc Dc, the floatation amount H should be advantageously small (specifically, 2 μm (2000 nm) through 4 μm (4000 nm), or more preferably 3 μm (3000 nm)). In addition, in order to prevent miss-focusing of the beam condenser 3 mounted on the floating slider 1, the floatation amount H of the floating slider 1 should not change. In order to satisfy these conditions, the magneto-optical storage device 10 has the following specifications for an opposing face 11 (See FIG. 2 and FIG. 4) of the floating slider 1 which is a surface opposed to the magneto-optical disc Dc:

Specifically, as shown in FIG. 4, the opposing face 11 of the floating slider 1 has a crown surface 7 which is like an outer surface of a cylinder. The crown surface 7 has an axis in the radial directions of the magneto-optical disc Dc. With the above arrangement in the floating slider 1, when air flows in between the crown surface 7 and the magneto-optical disc Dc, the air between the magneto-optical disc Dc and a region more upstream than the lowest point 7a forms a fluid wedge. When the flow of air increases, then the fluid wedge exerts an increased pressure, floating the floating slider 1 against the elastic force from the suspension member 5 and the weight of the floating slider 1.

The floating slider 1 is a so called monorail slider, in which the entire crown surface 7 is formed as a single surface, differing from a type in which the crown surface 7 is divided by a groove. Therefore, according to the floating slider 1, floating force exerted by the increased pressure of the fluid wedge is generally uniform on the entire surface of the crown surface 7, and thus the fluctuation in the floatation amount H can be reduced.

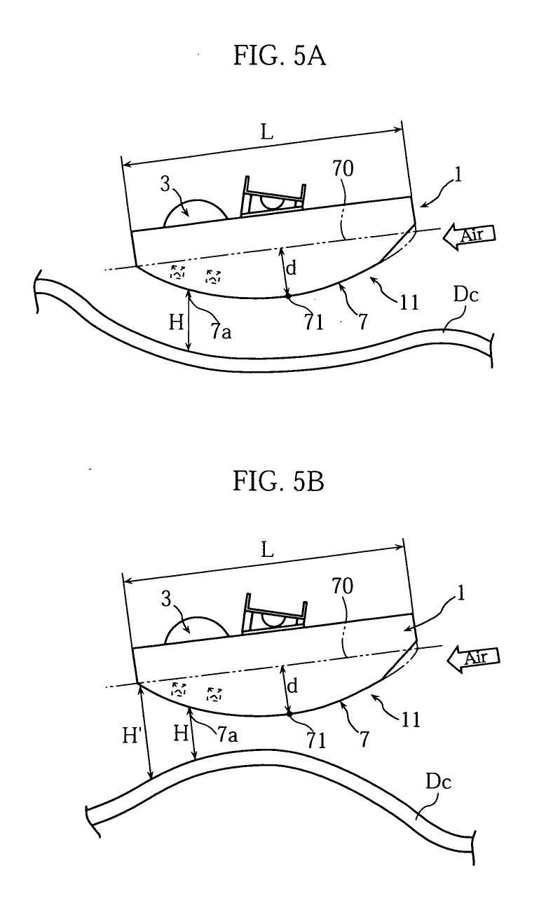

The magneto-optical disc Dc is made of a formed resin substrate as described earlier and therefore has undulations on its surface, which can increase fluctuation in the floatation amount H of the floating slider 1. More specifically, as shown in FIG. 5A, the floating slider 1 can maintain its floatation amount H above a recess of the magneto-optical disc 1 because the crown surface 7 can follow the contour. On the other hand, especially when above a bulge of the magneto-optical disc 1 as shown in FIG. 5B, where a distance H′ between the magneto-optical disc Dc and a region more downstream than the lowest point 7a is excessively larger than the floatation amount H of the floating slider 1, the air which has passed between the floating slider 1 and the magneto-optical disc Dc expands adiabatically, making it difficult for the floating slider 1 to float off the surface of the magneto-optical disc Dc and resulting in decrease in the floatation amount H.

In the above, change in the distance H′ is largely attributable to influences from: a crown thickness d given as a distance between a vertex 71 of an arc in a section of the crown surface 7 and its chord 70; and a slider length L given as a length of the opposing face 11 in parallel to the chord 70. Therefore, it should be possible to reduce the fluctuation in the flotation amount H by selecting appropriate values for the crown thickness d and the slider length L.

As a note for sizes of the floating slider 1: The smallest dimensions in use for the diameter of the second object lens 32 and the width of the gimbal spring 6 are about 0.5 mm and 1 mm respectively, and average dimensions are 2 mm and 2 mm respectively. From these values, the slider length L should preferably be 2 mm through 6 mm, and more preferably about 6 mm. On the other hand, the slider should have a width W, i.e. a dimension of the opposing face 11 radially of the magneto-optical disc Dc, which is preferably 1.2 mm through 5 mm, and more preferably about 4 mm.

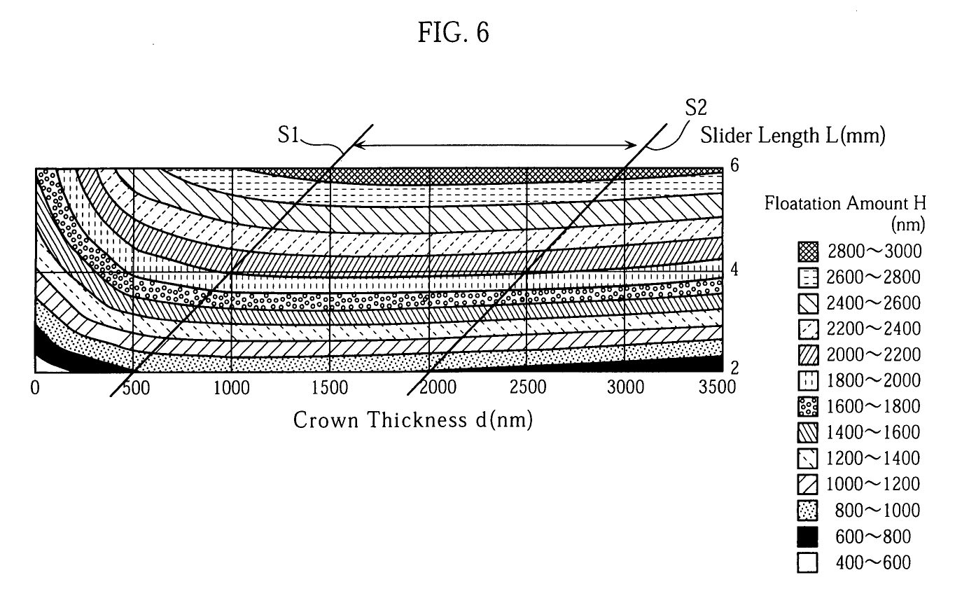

FIG. 6 shows a result of simulation on a relationship among the crown thickness d, the slider length L and the floatation amount H of the floating slider 1. In this simulation, the width W of the slider was 4.1 mm.

When the surface of storage medium has undulations, as in the case of removable magneto-optical disc Dc which includes a substrate made of a formed resin, consideration must be made to the following: Specifically, when the floating slider 1 is moving over a recess on the storage medium (FIG. 5A), the situation is equivalent to a case where the curvature radius of the opposing face 11 is increased. Conversely, when the floating slider 1 is moving over a bulge on the storage medium (FIG. 5B), the situation is equivalent to a case where the curvature radius of the opposing face 11 is decreased. In other words, when the floating slider 1 is to be floated over a removable storage medium having the surface which is prone to undulation, the situation is equivalent to a case where the opposing face 11 has a dynamically changing curvature radius. Since the curvature radius of the opposing face 11 is a value determined by the crown thickness d and the slider length L, in order for the floatation amount H to be appropriate, selection must be made for a region in FIG. 6 where changes in the crown thickness d do not result in big changes in the floatation amount H. Specifically, it is necessary to choose the crown thickness d for which gradient of the belt for each floatation amount H is small.

More specifically, referring to FIG. 6, if the slider length L is 2 mm, gradient of the belt for each floatation amount H is small when the crown thickness d is between 500 nm and 2000 nm. Likewise, if the slider length L is 4 mm, gradient of the belt for each floatation amount H is small when the crown thickness d is between 1000 nm and 2500 nm. Similarly, if the slider length L is 6 mm, gradient of the belt for each floatation amount H is small when the crown thickness d is between 1500 nm and 3000 nm.

As described above, when selection is made for regions where gradient of the belt for each floatation amount H is small, i.e. regions where there is no big change in the floatation amount H, an attention will be drawn to a region sandwiched by Lines S1 and S2 in FIG. 6. It becomes possible to prevent fluctuation in the floatation amount H if the slider length L and the crown thickness d are selected within this range. In other words, with L representing the slider length L and d representing the crown thickness d, the following conditions should be satisfied:
250(nm/mm)×L(mm)≦d(nm)≦250(nm/mm)×L(mm)+1500(mm)
Specifically, when the slider length L is a preferred value, i.e. 2 mm through 6 mm, then the crown thickness d should be 500 nm through 3000 nm. Further, if the slider length L is the more preferred value, i.e. 6 mm, then the crown thickness d should be 1500 nm through 3000 nm.

In the simulation, the magneto-optical disc Dc was assumed to be driven at a relative line speed of about 3 m/s with respect to the floating slider 1. The floating slider 1 was assumed to be pressed onto the magneto-optical disc Dc at a pressure of about 4 gf by elasticity of the suspension member 5 and the weight of the floating slider 1. It looked that changes in these conditions (the magneto-optical disc, and settings of the relative line speed and the pressing force) will not alter fluctuation patterns of the floatation amount H of the floating slider 1. Therefore, the same conditions were used for other simulations described in the present specification.

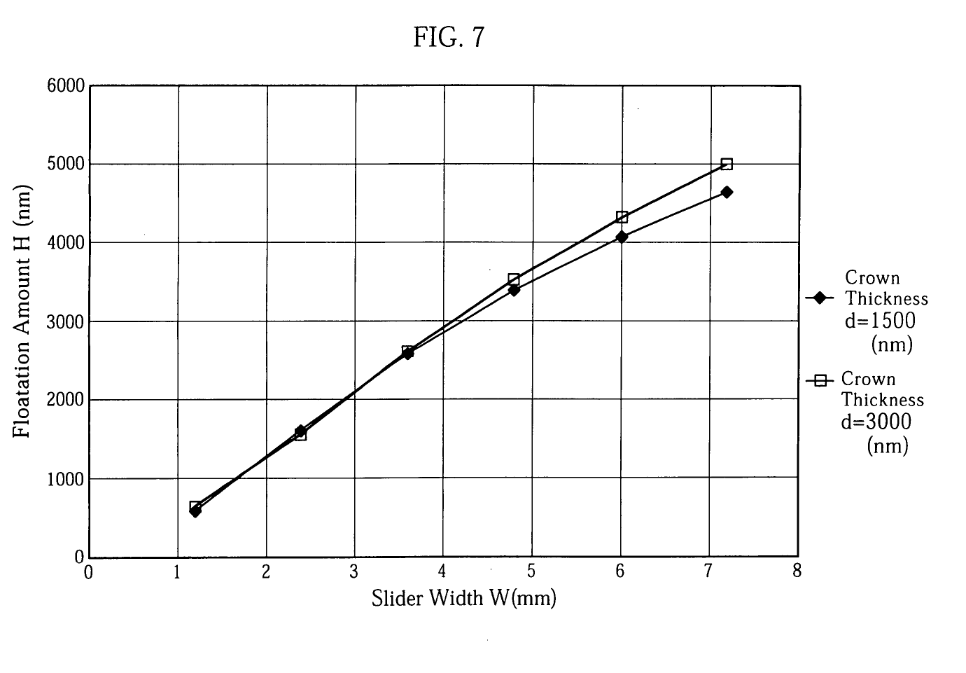

FIG. 7 shows a result of simulation on a relationship between the slider width W and the floatation amount H of the floating slider 1. In this simulation, the slider length L was set to 6 mm, and the crown thickness d was selected to be 1500 nm and 3000 nm, from the simulation in FIG. 6. FIG. 7 indicates that if the slider width W has a preferred value, i.e. 1.2 mm through 5 mm, rate of increase in the floatation amount H with respect to rate of increase in the slider width W is generally equal at both of the crown thickness d=1500 nm and d=3000 nm. This indicates that the fluctuation range of the floatation amount H is not affected by the slider width if the slider with W is 1.2 mm through 1.5 mm. In other words, fluctuation in the floatation amount H of the floating slider 1 can be prevented.

Thus, from the above consideration, it is possible to prevent fluctuation in the floatation amount H of the floating slider 1 if the slider length L is 2 mm through 6 mm, the slider width W is 1.2 mm through 5.0 mm, and the crown thickness d is 500 nm through 3000 nm. Further, in order to achieve the more preferred floatation amount H, i.e. H=3 μm (3000 nm), the slider length L should be about 6 mm, the slider width W should be about 4 mm, and the crown thickness d should be 500 nm through 3000 nm.

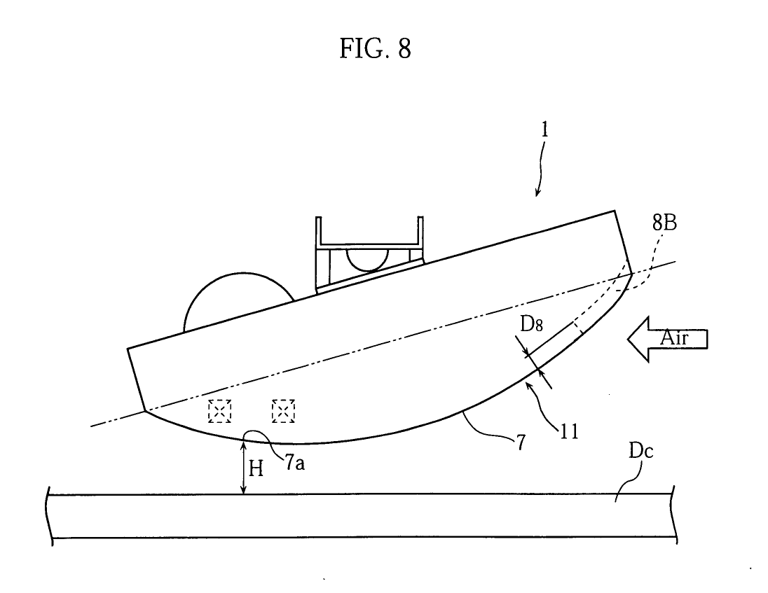

Further, in the magneto-optical storage device 10, as shown in FIG. 4 and FIG. 8, the floating slider 1 has a flow entering end 80, from which air flows in, formed with a tapered flat surface 8A or a recessed step 8B. The tapered surface 8A and the step 8B prevent the floatation amount H of the floating slider 1 from being altered by a build up of airborne dusts on the crown surface 7. More specifically, because the magneto-optical disc Dc is a removable medium, it is exposed to contaminated air at the time of loading and unloading the disc, and can catch airborne dust. The dust is a particle of cigarette smoke for example, which has an average size of 0.7 μm. When the magneto-optical disc Dc is turning, the dust can attach to a relatively upstream side of the crown surface 7, and builds up eventually to form a bulge on the crown surface 7. When the bulge has grown to have a height of about 1 μm, air hitting the bulge generates a negative pressure between the crown surface 7 and downstream side surfaces of the bulge, decreasing the floatation amount H of the floating slider 1. The tapered surface 8A directs the air flow in a slightly downward direction, thereby preventing the dust from attaching to the crown surface 7. On the other hand, the step 8B allows the dust to attach on its recess, thereby prevents the dust from forming a bulge big enough to come out of the crown surface 7. Thus, it becomes possible to prevent the fluctuation of the floatation amount H, with the tapered surface 8A or the step 8B.

In the tapered surface 8A, let M8 represent a length along the chord 70 of the crown surface 7, and 0 represent a slanting angle with respect to the chord 70 of the crown surface 7. Then, M8 and the angle θ are specified as follows: Since a large length M8 will affect the floatation amount H of the floating slider 1, a small length M8 is preferred, and on the other hand, there is machining difficulty to achieve M8 which is not greater than 0.3 mm. Thus, a preferred range of M8 is 0.3 mm through 0.5 mm. If the angle has a large value, the dust will build up on the tapered surface 8A, so the value of the angle θ should be small. Then, with manufacturing error of 0.25 degrees taken into account, a preferred range of e is 0.5 degrees through 1.0 degree.

In the step 8B, let D8 represent a depth from the opposing face 11 of the floating slider 1. Then, D8 is specified as follows: As has been described earlier, since the bulge can alter the floatation amount H when grown to have a height of about 1 micron meter, a preferred range of D8 is 1 μm through 5 μm.

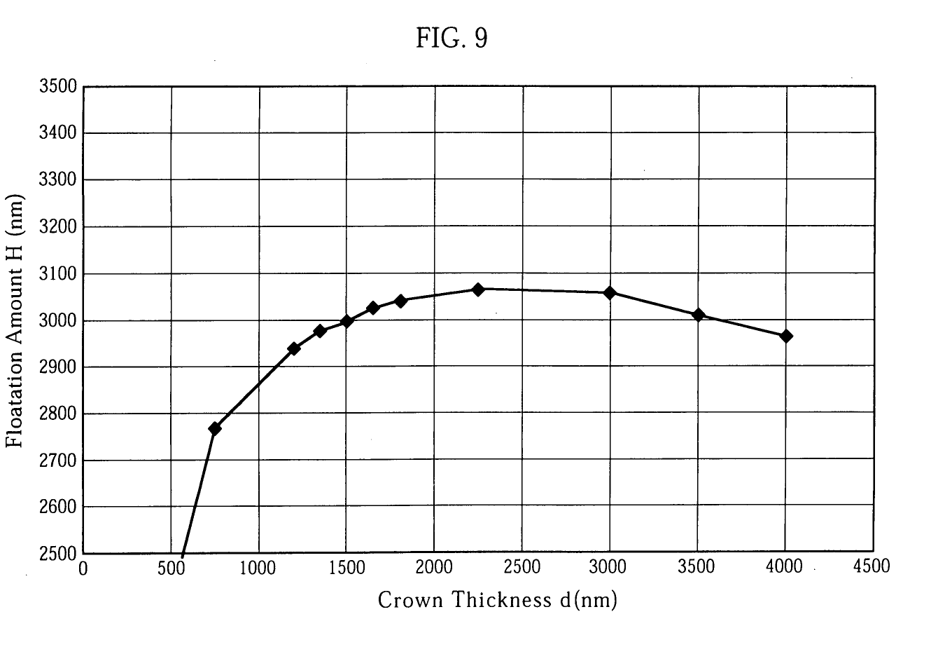

FIG. 9 shows a result of simulation made on a floating slider 1 according to the present invention. In this simulation, the slider length L was 6 mm, the width W of the slider was 4.1 mm, the length M8 of the tapered surface 8A was 0.3 mm, the angle θ of the tapered surface 8A was 0.5 degrees. The figure shows a result of simulation on the relationship between the crown thickness d and the floatation amount H of the floating slider 1. This figure confirms that the crown thickness set between 1500 nm through 3000 nm can float the floating slider 1 by the desired amount, i.e. H=about 3 μm (3000 nm), while preventing the fluctuation in the amount of floatation.

The present invention has thus far been described as the above, it is obvious that the present invention can be varied in many ways. Such variations should not be taken as deviation from the technical idea and scope of the present invention. All and any variation obvious to those skilled in the art should be included in the scope of the following claims.

1. A floating slider including an opposing face opposed to a storage medium, the opposing face having a crown surface like an outer columnar surface having an axis extending radially of the storage medium, the floating slider being floated off the storage medium by air flowing in between the storage medium and the opposing surface,
wherein the following expression is satisfied where d represents a crown thickness defined as a distance from an vertex of an arc in a section of the crown surface to a chord of the arc, and L represents a slider length defined as a length of the opposing face parallel to the chord:
250(nm/mm)×L(mm)≦d(nm)≦250(nm/mm)×L(mm)+1500(mm)

2. The floating slider according to claim 1, wherein the opposing face has an air entering end formed with a tapered flat surface having a length of 0.3 mm through 0.5 mm toward the chord and crossing the chord at an angle of 0.5 degrees through 1.0 degree.

3. The floating slider according to claim 1, wherein the opposing face has an air entering end formed with a recessed step having a depth of 1 μm through 5 μm.

4. The floating slider according to claim 1, wherein the floating slider is a monorail slider in which the entire crown surface is formed as a single surface.

5. The floating slider according to claim 1, wherein the slider length is 2 mm through 6 mm, a slider width defined as a distance of the opposing face radially of the storage medium is 1.2 mm through 5.0 mm, and the crown thickness d is 500 nm through 3000 nm.

6. The floating slider according to claim 1, wherein the slider length is approximately 6 mm, the slider width defined as a distance of the opposing face radially of the storage medium is approximately 4 mm, and the crown thickness d is 1500 nm through 3000 nm.

7. A magneto-optical storage device including a light condenser for formation of a laser spot on a storage medium and a magnetic field generator for generation of a magnetic field at a region where the laser spot is formed,
wherein the light condenser and the magnetic field generator are mounted on the floating slider according to claim 1.
